(19) United States
(12) Patent Application Publication
(10) Pub. No.: US 2008/0090056 A1
(43) Pub. Date: Apr. 17, 2008

(54) Printed film laminate having a protective repairable layer

(76) Inventor: David James Horwitz, Savannah, GA (US)

Correspondence Address: J. BENNETT MULLINAX, LLC, P. O. BOX 26029, GREENVILLE, SC, 29616-1029, US

(21) Appl. No.: 11/581,827

(22) Filed: Oct. 17, 2006

(51) Int. Cl. B32B 3/00

(52) U.S. Cl. 428/204

(57) ABSTRACT

A printed film laminate is provided. The printed film laminate includes a top layer that is made of a thermoformable polymer. An ink layer and a film layer and also present. The ink layer is located between the top layer and the film layer. The ink is protected by the top layer and the film layer. The top layer, ink layer and film layer are attached to one another for subsequent application to a base layer.

### FIELD OF THE INVENTION

The present invention relates generally to printed film laminates. More particularly, the present application involves a printed film laminate that can be used to simulate a wood grain finish that has a protective layer capable of being repaired when scratched so that noticeable degradation of the laminate does not exist.

### BACKGROUND

Various types of materials are used in the construction of furniture such as desks, cabinets, tables, book shelves and the like. Material used in these items can range widely in both quality and cost. For example, relatively low cost material such as molded plastic and particle board laminates may be employed. Wood and mid-range plastic laminates can also be used. Further, premium wood materials and metal can be used in items of higher quality and cost. Although described as being used in furniture, it is to be understood that the various types of materials can be incorporated into other items such as wall protection products and flooring.

Thermoplastic materials, such as polyvinyl chloride, can be extruded in order to form furniture such as tables, shelves and chairs. Scratches and other surface flaws on the thermoplastic material can be removed by using steel wool, sand paper or a buffing pad. One can apply the buffing element to the surface of the furniture so that the scratch or other surface flaw is worn away to thus improve the furniture's appearance. This type of repair may work well when the damaged area is small and located in a relatively inconspicuous location of the furniture. However, when larger surfaces of the furniture such as tabletops, shelves and seats are repaired in this manner the resulting buffed area may be noticeably different than the untreated, surrounding area. For example, a piece of furniture with a smooth finish thermoplastic sheet surface may be left with a dull spot that has noticeably reduced gloss and shine when repaired. As such, while the scratch or surface imperfection is removed, the buffing process in these instances results in the repaired location having a different look than the surrounding thermoplastic.

Furniture made of wood can be repaired and restored to its original finish when damaged. The damaged area can be sanded so that the scratch, nick or other abrasion is removed. Next, the sanded area can be stained and refinished to match the original appearance of the article. While such a repair provides aesthetically pleasing results, a great deal of skill in making this repair is required and hence significant time, money and effort must be expended.

Furniture that is made of laminated particle board typically includes a printed layer that is present in order to give a wood-like look to the product. The printed layer is made of a film that carries ink that acts to provide the wood-like appearance. The ink is placed under the film so as to make a reverse print. In a laminated particle board arrangement, the ink is located between the particle board and the film. A coating is placed over the film in order to protect the printed layer. The coating is a thin, hard layer that is sprayed onto the printed layer. It is usually the case that the coating is only a few microns thick. Once scratched, the coating cannot be repaired. Additionally, as the coating is extremely thin, a scratch could potentially be made through the coating and into the printed layer thus significantly detracting from the appearance of the furniture.

Adhesion is also problematic with respect to laminated particle board in furniture. The coating is made of a different material than the film of the printed layer. As such, coefficients of expansion between the coating layer and film layer are different thus resulting in inconsistencies and tearing in the application of adhesion to hold these components together. If the various layers of the laminated particle board are not properly adhered, one or more layers can peel off or otherwise become disengaged at the location of the scratch or abrasion. Further, edges or corners of the laminated particle board may experience peeling if the various layers are not properly adhered.

### SUMMARY

Various features and advantages of the invention will be set forth in part in the following description, or may be obvious from the description, or may be learned from practice of the invention.

One aspect of the present invention provides for a printed film laminate. The laminate includes a top layer that is made of a thermoformable polymer. An ink layer and a film layer are present. The ink layer is located between the top layer and the film layer. The ink is protected by the top layer and the film layer. The top layer, ink layer and film layer are attached to one another for subsequent application to a base layer.

Another aspect of the present invention exists in a printed film laminate as immediately discussed in which the top layer has ceramic particles imbedded therein.

A further aspect of the present invention is found in a printed film laminate as previously mentioned that includes a base layer made of particle board.

An additional aspect exists in a printed film laminate as mentioned above in which the film is made of a thermoplastic vinyl. The thermoformable polymer of the top layer is also made of thermoplastic vinyl. The top layer, ink layer and film layer are formed into a solid matrix using extruder rolls.

Another exemplary embodiment of the present invention is found in a printed film laminate as previously mentioned in which the ink layer is applied to the bottom of the top layer. The film layer is then subsequently applied to the top layer and the ink layer.

A further aspect of the present invention is provided in a printed film laminate that has a top layer that is made of thermoplastic vinyl. A film layer is present that has a film also made of thermoplastic vinyl. The top layer and the film layer are formed into a solid matrix using extruder rolls. Also, ink is present and is disposed on the film. A base layer is also present and is contiguous with the solid matrix of the top layer and the film layer. The top layer and the film layer are preformed and subsequently applied to the solid matrix of the top layer and the film layer.

Yet another aspect of the present invention is found in a printed film laminate as immediately discussed in which the ink is located between the film and the top layer.

A further aspect of the present invention exists in a printed film laminate as previously mentioned in which the film of the film layer is contiguous with the base layer.

Additionally, an exemplary embodiment of the present invention is found in a printed film laminate as previously mentioned in which the top layer is transparent and has ceramic particles imbedded therein.

Another aspect of the present invention resides in a printed film laminate as all ready mentioned in which the ink is continuous across the film. Further, the ink is provided so as to simulate the look of a wood grain surface.

Also found in accordance with one aspect of the present invention is a printed film laminate as mentioned above in which the top layer has a thickness from 0.3 millimeters to 3 millimeters.

The present invention also includes, in one aspect, a printed film laminate as mentioned above in which scratches in the top layer are repairable. In this regard, a buffing element that can be sand paper, steel wool, or a buffing pad can be used to repair the scratch so that the repaired area matches the finish of the surrounding area of the top layer.

Another aspect of the present invention resides in a printed film laminate as mentioned above in which the top layer and the film layer have the same coefficient of expansion.

A further aspect of the present invention is found in a printed film laminate. The printed film laminate includes a top layer that is made of a transparent thermoplastic vinyl with ceramic particles imbedded therein. The top layer is from 0.3 millimeters to 3 millimeters in thickness. A film layer is present and includes a film made of thermoplastic vinyl. The film has ink disposed thereon that is continuous across the film. The ink is provided in order to simulate the look of a wood grain surface. The ink is located between the top layer and the film. The top layer and the film are formed into a solid matrix using extruder rolls. The coefficient of expansion of the top layer and the film layer is the same. Additionally, a base layer is present and is made of particle board. The base layer is contiguous with the film layer.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a side view of a printed film laminate used in accordance with one exemplary embodiment of the present invention.

FIG. 2 is a perspective view of a scratched table that includes a printed film laminate in accordance with one exemplary embodiment of the present invention.

FIG. 3 is a perspective view of the table of FIG. 2 with the scratch repaired so that the repaired area has a finish that is similar to the surrounding area.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a printed film laminate 10 that can be used in the construction of items such as furniture, flooring and wall protection. The printed film laminate 10 may be made so that an ink layer 14 is located between a film layer 16 and a top layer 12. The ink 14 can be deposited onto film 15 to form a film layer 16 which is subsequently attached to the top layer 12. Alternatively, the ink layer 14 can be placed onto the bottom of the top layer 12 and then these components can be subsequently applied to the film layer 16. The top layer 12 can be made out of a thermoplastic vinyl and can be repaired with sand paper, steel wool or a buffing pad when scratched or otherwise damaged. In accordance with one exemplary embodiment, the top layer 12 and film 15 of the film layer 16 are made of thermoplastic vinyl and are formed into a solid matrix using extruder rolls. The top layer 12 and film layer 16 in this embodiment may have the same coefficient of expansion so as to better adhere to one another during formation.

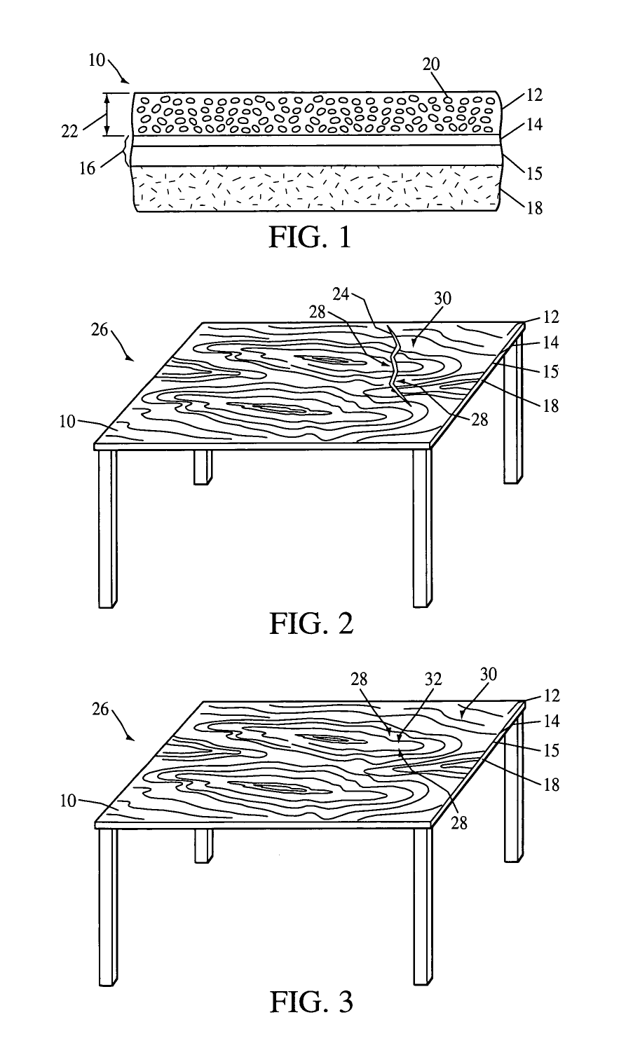

One exemplary embodiment of the printed film laminate 10 used in the construction of furniture is shown in FIG. 1. Here, a base layer 18 made of particle board is attached to a film layer 16. Although the base layer 18 shown is made of particle board, it is to be understood that the base layer 18 can be made of various materials in accordance with other exemplary embodiments. For example, base layer 18 could be made of solid wood, metal, paper or plastic in accordance with other embodiments. The base layer 18 may be made of particle board and by processes as those described in U.S. Pat. No. 5,480,602 to Nagaich and U.S. Pat. No. 4,428,897 to Lowenkron et al. The entire contents of U.S. Pat. Nos. 5,480,602 and 4,428,897 are incorporated by reference herein in their entirety for all purposes.

Ink 14 is located between a top layer 12 and film 15 of the film layer 16. Placement of the ink 14 in this manner acts to protect the ink 14 during formation and subsequent application of the top layer 12, ink 14 and film 15 to the base layer 18. The ink 14 is in effect protected on both sides by the top layer 12 and the film 15. The ink 14 can be continuous across a substantial portion of both the film 15 and top layer 12. Alternatively, the ink 14 may be discontinuous across these components. The ink 14 can be provided so as to mimic the lines, color and features of a wood surface so that the resulting printed film laminate 10 has a look that simulates a structural wood grain surface. The ink 14 thus applies a desired pigmentation to the film 15 so that the film layer 16 displays a desired pattern. Film 15 can be made of a variety of materials and, in accordance with certain exemplary embodiments, is made of thermoplastic vinyl. The film 15 can be of any thickness. In accordance with certain exemplary embodiments the film 15 is from 2 millimeters to 8 millimeters thick.

Although described as including both the ink 14 and film 15, the film layer 16 need only include the film 15 and not the ink 14 in accordance with various exemplary embodiments. Further, other components besides or in addition to ink 14 can be incorporated into the film layer 16 in yet other embodiments. In a similar manner, the top layer 12 may or may not include ink 14 in accordance with certain exemplary embodiments in addition to or alternatively to other components that may be incorporated into the top layer 12. The ink layer 14 may include only ink 14 in certain embodiments or may include components in addition to ink 14 in other embodiments.

The ink 14 and the film 15 can be attached to one another and formed into a film layer 16 known as a foil. In this regard, the foil can be formed by source printing ink 14 on top of the film 15. The foil, which is made up of the ink 14 and the film 15, can then be laminated to the top layer 12. This method of formation does not require the ink 14 to be reverse printed to either the film 15 or to the top layer 12. However, other embodiments of the present invention exist in which the ink 14 may be reverse printed. Although described as a printed film laminate 10, it is to be understood that the use of this term herein relates to the fact that the ink 14 is disposed onto one or more components of the laminate and is consequently printed. The ink 14 can be disposed onto the various components in a number of different ways in accordance with various exemplary embodiments.

The top layer 12 can be made of a thermoformable polymer that has ceramic particles 20 embedded therein. In accordance with one exemplary embodiment of the present invention, the top layer 12 is a thermoplastic extruded PVC sheet. The top layer 12 can have a thickness 22 that is from 0.3 millimeters to 3 millimeters in length. However, it is to be understood that the thickness 22 of the top layer 12 may be different in accordance with other exemplary embodiments. For example, thickness 22 can be up to 10 millimeters in length. Further, thickness 22 can be from 2 millimeters to 5 millimeters in accordance with other exemplary embodiments. The top layer 12 can be transparent so that the pattern formed by the ink 14 underneath is visible once incorporated into the finished product. In this regard, the top layer 12 can have varying degrees of transparency. The top layer 12 can be completely transparent or may be semi-transparent so that the view of the film layer 16 is somewhat obscured. The film layer 16 has previously been described as having ink 14 source printed or otherwise applied to the film 15. It is to be understood that in certain exemplary embodiments of the present invention that the ink 14 is applied to the top layer 12 and then subsequently the film 15 is attached. Here, the ink 14 may be reverse or bottom printed onto the bottom surface of the top layer 12 so that when incorporated into a finished article, the thickness of the top layer 12 protects the printed image. The top layer 12 can be substantially transparent so that the ink 14 can be clearly viewed, or the top layer 12 can be transparent and dyed or tinted so that the ink 14 appears to be a different color. In alternative arrangements, ink 14 can be applied to both the top layer 12 and to the film 15. Subsequently, the top layer 12 and the film 15 can be attached to one another so that the ink 14 is located therebetween. In these embodiments, the top layer 12 can again be substantially clear or may be tinted as desired.

The printed film laminate 10 in accordance with one exemplary embodiment of the present invention may be formed at least in part through an extrusion process. Here, the top layer 12 and the film 15 are made of thermoplastic vinyl. The film 15 is printed with ink 14 to form the film layer 16. The film layer 16 and the top layer 12 are then formed into one solid matrix through the use of extrusion rolls. In this manner, the film layer 16 and the top layer 12 are adhered to one another through the use of heat and pressure. As both the film layer 16 and top layer 12 are made of thermoplastic vinyl, the coefficient of expansion of these components is identical to one another. The top layer 12 and film layer 16 better adhere to one another when thermally fused due to the fact that their expansion properties are similar. The solid matrix of the top layer 12 and film layer 16 can then be subsequently applied to the base layer 18 in the formation of a finished product. In this regard, the solid matrix of the top layer 12 and film layer 16 can be mechanically fastened or adhered through use of adhesives to the base layer 18. Additionally or alternatively, the matrix having the top layer 12 and the film layer 16 can be attached to the base layer 18 through the application of heat and pressure. Although described as being formed through extrusion and made of the same materials, it is to be understood that the aforementioned components of the printed film laminate 10 can be formed by way of other processes and be made of various materials in accordance with other exemplary embodiments.

Although described as having film 15 or a film layer 16, the printed film laminate 10 need not have this component in accordance with other exemplary embodiments. For example, the printed film laminate 10 may include just the top layer 12 that carries ink 14. The top layer 12 and ink 14 could, if desired, be subsequently applied to the base layer 18, or to a film 15 or film layer 16 which could likewise be subsequently applied to the base layer 18. In this manner, the ink 14 can be located on the bottom of the top layer 12 and these components may be configured for subsequent application to a film 15 and/or base layer 18. It is therefore to be understood that various exemplary embodiments exist in which the ink 14 can be carried by the top layer 12 in which the presence of the film 15 and/or film layer 16 is optional.

FIG. 2 shows the printed film laminate 10 incorporated into a piece of furniture that in this instance is a table 26. Although shown included into a table 26, the printed film laminate 10 may be incorporated into various items in accordance with other exemplary embodiments. For example, the printed film laminate 10 may be used in the construction of chairs, stools, desks, wall protection, flooring, bookshelves and credenzas. As shown, a scratch 24 is present in the printed film laminate 10. Such a scratch 24 can be made, for instance, by inadvertently running a sharp object such as the point of a staple or scissors across the outer surface 30 of the top layer 12.

The table 26 can be repaired with the use of a buffing element such as sand paper, steel wool or a buffing pad. The user can rub the buffing element across the portion of the outer surface 30 that contains the scratch 24. This action causes a portion of the top layer 12 that contains the scratch 24 to be worn away thus removing the presence of the scratch 24. The repaired area 32 is shown in FIG. 3. The thickness 22 of the top layer 12 is of a length sufficient to still allow for the presence of the top layer 12 above the ink 14 in the repaired area 32. As such, the look of the repaired area 32 is similar to the look of the surrounding areas 28, which are the surrounding non-damaged portions of the printed film laminate 10.

The printed film laminate 10 can be preformed in the sense that the top layer 12 and the film layer 16 are formed and attached to one another before subsequent application to the base layer 18. As such, the top layer 12 and film layer 16 can be provided as a preformed sheet to a manufacturer for application to particle board for use in constructing a piece of furniture. It is to be understood, however, that certain exemplary embodiments of the present invention exist in which the top layer 12 and the film layer 16 are not preformed. In this regard, the film layer 16 can be applied to the base layer 18 and subsequently the top layer 12 can be applied to the film layer 16.

The outer surface 30 of the top layer 12 may be either smooth or rough. Additionally, the outer surface 30 can be contoured or provided with various features to improve the reparability of the printed film laminate 10. For example, a plurality of substantially straight, parallel grooves may be defined in the outer surface 30. An embossing roller, sandpaper, steel wool, a die stamping press, sandblasting, laser ablation, or other cutting instruments may be used to form the grooves. The grooves can have a depth from 25 to 100 microns and can be spaced up to 20 microns apart. The presence of grooves may act to allow the repaired area 32 to more closely match the surrounding area 28 in certain circumstances. However, it is to be understood that various exemplary embodiments exist in which the outer surface 30 does not have grooves defined thereon.

The printed film laminate 10 can be treated by processes or with materials in order to make the laminate 10 more abrasion and scratch resistant. For example, as shown in reference to FIG. 1, ceramic particles 20 can be added to the top layer 12 to impart greater wear and scratch resistance to the printed film laminate 10. Although described as being ceramic, the particles 20 can be variously configured in accordance with other exemplary embodiments. For instance, the particles 20 added to the top layer 12 can be silicates, silica oxide, fumed silica, alumina, or alumina oxides in addition to being ceramics, ceramic microspheres and combinations thereof. The particles 20 may be in a granular form, preferably have high hardness values, and typically have a generally spherical shape. However, other shapes of particles 20 as well as variations in particle sizes may be used which will offer satisfactory results of improved scratch resistance. Further, the particles 20 in a particular top layer 12 can all be of the same shape and size or may have varying shapes and sizes. In a like manner, the particles 20 of a particular top layer 12 may be all of the same material or may be made of varying materials in accordance with different embodiments.

In one embodiment, the particles 20 have a particle size from 4 to 10 microns. The concentration of particles 20 in the printed film laminate 10 may be such that from 1% to 10% of the weight of the printed film laminate 10 is made up of the particles 20. Generally, an increase in the amount of particles 20 increases the cut and scratch resistance of the resulting printed film laminate 10. As the printed film laminate 10 is more tolerant to damage, it will need to be repaired less often and if damaged will require less extensive repair work. The particles 20 can be mixed substantially uniformly through the top layer 12 or can be concentrated at strategic locations. For example, the particles 20 may be concentrated at the outer surface 30 of the top layer 12 or can be concentrated along one or more edges.

The particles 20 may be incorporated into the top layer 12 prior to extrusion of the top layer 12 with the film layer 16. In this regard, the particles 20 can be added during the compounding stage of the top layer 12 prior to the polymer extrusion. Alternatively, a dosing screw or other metering device may be used to introduce the particles 20 directly to the extruder. In certain exemplary embodiments, the particles 20 can be applied to the surface of a molten top layer 12 as the molten top layer 12 exits an extruder die. The particles 20 can be applied by a pneumatic sprayer, a mechanical duster, or through electrostatic dispersion. The particles 20 can be applied at a concentration from 1 to 25 grams per square meter. Application of the particles 20 prior to cooling of the molten top layer 12 allows for the particles 20 to be mechanically pressed into the upper molten polymer layer by the use of pressure. Such pressure can be applied by the use of nip rollers or by the use of a pressure responsive platen. A pressure roller, nip roller, or calendaring roll can be used to apply a pressure from 150 to 200 pounds per linear inch to the top layer 12 during extrusion.

An additional way of impregnating the printed film laminate 10 with the particles 20 takes place after initial formation and adhesion of the top layer 12 and the film layer 16. Here, the top layer 12, and possibly the film layer 16, is heated to a surface softening temperature and the particles 20 are applied to the outer surface 30. Following application, mechanical pressure is applied in order to force the particles 20 into various depths of the top layer 12. If desired, the particles 20 can be heated to a temperature greater than the softening temperature of the top layer 12 before being applied to the outer surface 30. Heating of the particles 20 in this manner may allow the particles 20 to more easily adhere to the applied portions of the top layer. The use of particles 20 to increase the scratch resistance of a thermoplastic article is disclosed in U.S. patent application Ser. No. 11/359,093 filed Feb. 22, 2006 and assigned to Duracase Proprietary LLC whose inventor is David J. Horwitz. The entire contents of U.S. patent application Ser. No. 11/359,093 are incorporated by reference herein in their entirety for all purposes. Additionally, although disclosed as containing particles 20, it is to be understood that the present invention includes exemplary embodiments in which the particles 20 are not present in the printed film laminate 10.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

1. A printed film laminate, comprising:
a top layer made of a thermoformable polymer;
an ink layer;
a film layer, wherein said ink layer is located between said top layer and said film layer, wherein said ink is protected by said top layer and said film layer, and wherein said top layer said ink layer and said film layer are attached to one another for subsequent application to a base layer.

2. The printed film laminate as in claim 1, wherein said thermoformable polymer of said top layer is transparent polyvinyl chloride.

3. The printed film laminate as in claim 1, wherein said thermoformable polymer of said top layer has ceramic particles imbedded therein.

4. The printed film laminate as in claim 1, wherein said top layer has a thickness from 0.3 millimeters to 3 millimeters.

5. The printed film laminate as in claim 1, further comprising a base layer made of particle board that is contiguous with said film layer.

6. The printed film laminate as in claim 1, wherein scratches in said top layer are repairable by use of a buffing element selected from the group consisting of sand paper, steel wool and a buffing pad such that when repaired the repaired area matches the finish of the surrounding area of said top layer.

7. The printed film laminate as in claim 1, wherein said film layer is made of a thermoplastic vinyl, and wherein said thermoformable polymer of said top layer is thermoplastic vinyl, wherein said top layer said ink layer and said film layer are formed into a solid matrix using extruder rolls.

8. The printed film laminate as in claim 1, wherein said top layer and said film layer have the same coefficient of expansion.

9. The printed film laminate as in claim 1, wherein said ink layer is applied to the bottom of said top layer, and wherein said film layer is subsequently applied to said top layer and said ink layer.

10. The printed film laminate as in claim 1, wherein said top layer and said film layer are incorporated into an item selected from the group consisting of furniture, wall protection and flooring.

11. A printed film laminate, comprising:
a top layer made of thermoplastic vinyl;
a film layer having a film made of thermoplastic vinyl, wherein said top layer and said film layer are formed into a solid matrix using extruder rolls, wherein ink is disposed on said film; and
a base layer contiguous with said solid matrix of said top layer and said film layer, wherein said top layer and said film layer are preformed and subsequently applied to said solid matrix of said top layer and said film layer.

12. The printed film laminate as in claim 11, wherein said ink is located between said film and said top layer.

13. The printed film laminate as in claim 11, wherein said film of said film layer is contiguous with said base layer.

14. The printed film laminate as in claim 11, wherein said top layer is transparent and has ceramic particles imbedded therein.

15. The printed film laminate as in claim 11, wherein said top layer has a thickness from 0.3 millimeters to 3 millimeters.

16. The printed film laminate as in claim 11, wherein said top layer and said film layer have the same coefficient of expansion.

17. The printed film laminate as in claim 11, wherein scratches in said top layer are repairable by use of a buffing element selected from the group consisting of sand paper, steel wool and a buffing pad such that when repaired the repaired area matches the finish of the surrounding area of said top layer.

18. The printed film laminate as in claim 11, wherein said base layer is made of particle board, and wherein said top layer, said film layer and said base layer are incorporated into an item selected from the group consisting of furniture, wall protection and flooring.

19. The printed film laminate as in claim 11, wherein said ink is continuous across said film and is provided so as to simulate the look of a wood grain surface.

20. A printed film laminate, comprising:
a top layer made of a transparent thermoplastic vinyl with ceramic particles imbedded therein, said top layer being from 0.3 millimeters to 3 millimeters in thickness;
a film layer having a film made of thermoplastic vinyl, said film having ink disposed thereon that is continuous across said film and is provided so as to simulate the look of a wood grain surface, wherein said ink is located between said top layer and said film, wherein said top layer and said film layer are formed into a solid matrix using extruder rolls, and wherein the coefficient of expansion of said top layer and said film layer is the same; and
a base layer made of particle board contiguous with said film layer.

21. A laminate, comprising:
a top layer made of a transparent material; and
an ink layer disposed on the bottom of said top layer.

22. The laminate as set forth in claim 21, further comprising:
a film layer located so that said ink layer is located between said top layer and said film layer, wherein said ink layer is protected by said top layer and said film layer; and
a base layer located so that said film layer is located between said ink layer and said base layer;
wherein said top layer, said ink layer, said film layer and said base layer are incorporated into an item selected from the group consisting of furniture, wall protection and flooring.

23. The laminate as set forth in claim 21, wherein said transparent material making up said top layer is a thermoformable polymer that is transparent polyvinyl chloride, and wherein said ink layer is disposed across the entire bottom of said top layer.
